(19) United States
(12) Patent Application Publication
(10) Pub. No.: US 2021/0227954 A1
(43) Pub. Date: Jul. 29, 2021

(54) Mirror with Built-in Display Screens

(71) Applicant: Stacy Robinson, Pearland, TX (US)

(72) Inventor: Stacy Robinson, Pearland, TX (US)

(21) Appl. No.: 17/159,332

(22) Filed: Jan. 27, 2021

Related U.S. Application Data
(60) Provisional application No. 62/966,131, filed on Jan. 27, 2020.

(51) Int. Cl. A45D 44/00; G06F 3/14; A45D 42/08

(52) U.S. Cl. CPC A45D 44/005; A45D 42/08; G06F 3/1423

(57) ABSTRACT

A mirror with a built-in display screen comprises a first housing having a plurality of exterior walls. The first housing has a mirror element secured to a front side of the housing. A second housing comprises a plurality of exterior walls. A display screen is secured within the second housing such that the display screen is viewed when the mirror is viewed. The display screen is electrically coupled to a wireless transceiver and a power source. A second display screen is secured within a third housing such that the display screen is viewed when the mirror is viewed. The second display screen is electrically coupled to the wireless transceiver and the power source. The display screens show an image of the user with an outline around the location that makeup should be applied, so the user can fill in the outlined areas with their makeup.

### CROSS REFERENCE TO RELATED APPLICATIONS

This application claims the benefit of U.S. Provisional Application No. 62/966,131 filed on Jan. 27, 2020. The above identified patent application is herein incorporated by reference in its entirety to provide continuity of disclosure.

### BACKGROUND OF THE INVENTION

The present invention relates to mirrors. More particularly, the present invention provides mirror with a built-in display screen.

Many individuals use a mirror to prepare themselves for a host of different reasons. In some instances, individuals lack the expertise or knowledge to apply makeup in a desired style or fashion, which can result in an individual being unhappy and frustrated with the quality of their makeup application abilities. Such individuals may not have sufficient time to devote to developing such makeup application skills and thus resort to professional makeup application. Over time, the costs of a makeup professional may become excessive.

This leads to individuals wanting to learn to better apply make-up or other products. In today's world, this often means using video tutorials. It can be difficult to hold a display screen, watch a video, and to apply make-up at the same time. Further, it can be extremely difficult to compound that with attempting to locate the proper make-up as required by the tutorial for the desired technique.

Consequently, there is a need for an improvement in the art of using a mirror. The present invention substantially diverges in design elements from the known art while at the same solves a problem many people face when attempting to use a mirror and watch a video at the same time. In this regard the present invention substantially fulfills these needs.

### SUMMARY OF THE INVENTION

The present invention provides a mirror with a built-in display screen wherein the same can be utilized for providing convenience for the user when using a mirror and a display device at the same time. The mirror with a built-in display screen is comprised of a first housing comprising of a plurality of exterior walls. The first housing has a mirror element secured to a front side of the housing. A second housing is comprised of a plurality of exterior walls. A display screen is secured within the second housing such that the display screen is viewed when the mirror is viewed. The display screen is electrically coupled to a wireless transceiver and a power source. A third housing is comprised of a plurality of exterior walls. A second display screen is secured within the third housing such that the display screen is viewed when tine mirror is viewed. The second display screen is electrically coupled to the wireless transceiver and the power source.

A primary object of the present invention is to provide a mirror with a built in display screen that can be utilized to display an image of the user with an outline around a location that makeup should be applied, so the user can fill in the outlined areas with their makeup.

Another object of the mirror with a built-in display screen is to provide a first housing that is hingedly secured to the second housing.

Another object of the mirror with a built-in display screen is to have a base secured to one of the plurality of sidewalk of the first housing. The base will support the first housing and second housing.

Another object of the mirror with a built-in display screen is to have a plurality of device securing locations within the first housing.

Another object of the mirror with a built-in display screen is to have a plurality of make-up options secured within the first housing.

Another object of the mirror with a built-in display screen is to have a plurality of device securing locations within the first housing.

Another object of the mirror with a built-in display screen is to have a plurality of make-up options secured within the second housing.

Another object of the mirror with a built-in display screen is to have a plurality of device securing locations within the second housing.

Another object of the mirror with a built-in display screen is to have a plurality of make-up options secured within the third housing.

Another object of the mirror with a built-in display screen is to have a plurality of device securing locations within the third housing.

Another object of the mirror with a built-in display screen is to have the first housing is hingedly secured to the third housing.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the mirror with a built-in display screen.

FIG. 2 shows a perspective view of an alternative embodiment of the mirror with a built-in display screen.

FIG. 3 shows a front view of an embodiment of the mirror with a built-in display screen.

FIG. 4 shows rear view of an embodiment of the mirror with a built-in display screen.

FIG. 5 shows a wiring diagram of an embodiment of the mirror with a built-in display screen.

### LIST OF REFERENCE NUMERALS

With regard to the reference numerals used, the following numbering is used throughout the drawings.
101 Mirror element
102 Stand
103 First display screen
201 First housing
202 Plurality of sidewalk
203 Second housing
204 Sidewalk
205 Device holder
206 Make-up
207 Tray
301 Third housing
302 Sidewalk
303 Second display screen
304 Make-up brushes
401 Hinges
402 Fasteners
403 Widened base
501 Power source
502 Lights
503 Network
504 Wireless transceiver

### DETAILED DESCRIPTION OF THE INVENTION

Reference is made herein to the attached drawings. Like reference numerals are used throughout the drawings to depict like or similar elements of the mirror with a built-in display screen. For the purposes of presenting a brief and dear description of the present invention, a preferred embodiment will be discussed as used for the mirror with a built-in display screen. The figures are intended for representative purposes only and should not be considered to be limiting in any respect.

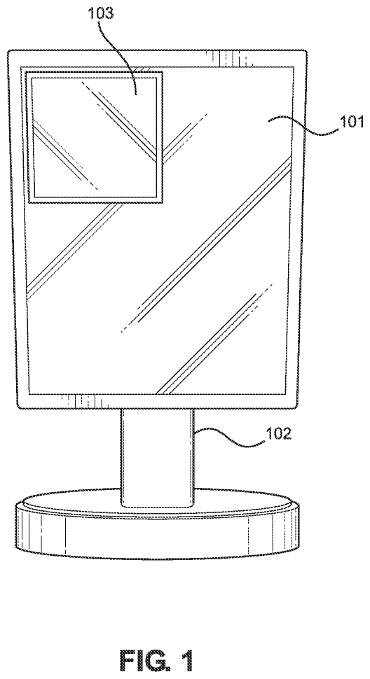

Referring now to FIG. 1, there is shown a perspective view of an embodiment of the mirror with a built-in display screen. The device includes at least one mirror element 101. In the shown embodiment, there is a single mirror element 101. In one embodiment, the mirror element 101 is made from glass. In another embodiment, the mirror element 101 will be made from a different reflective surface. This will allow for one or more apertures to be cut into the at least one mirror element 101 as required by the device.

The mirror with a built-in display screen further includes a stand 102. The stand 102 will hold the device in an elevated position. In one embodiment, there are additional stands to hold the device. In one embodiment, as described herein the stand is secured to the rear of the first housing.

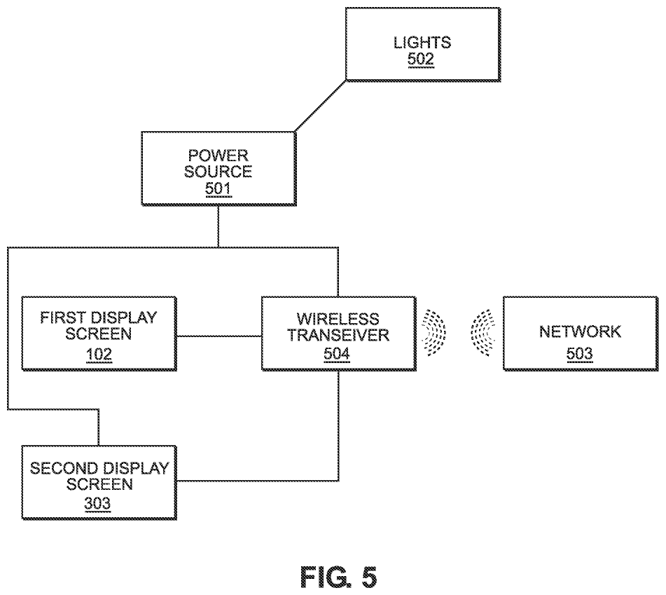

The device is comprised of at least a first display screen 103. In the shown embodiment, the first display screen 103 is fit within the at least one mirror element 101. This will allow for the easiest use of a display screen and a mirror at the same time. The display screen 103 is configured to display various pictures and videos from various sources as described in the description of FIG. 5.

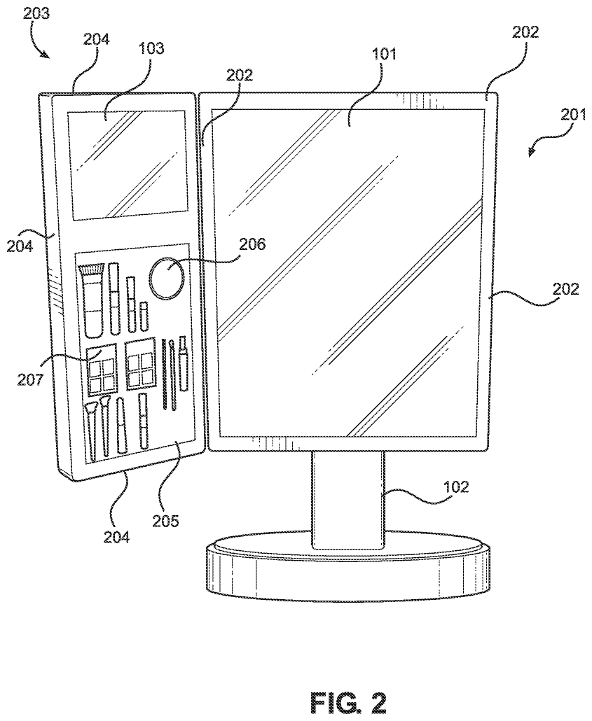

Referring now to FIG. 2, there is shown a perspective view of an alternative embodiment of the mirror with a built-in display screen. In one embodiment, the mirror with built-in display screen has a first housing 201. The first housing 201 is comprised of a plurality of sidewalk 202. In one embodiment, the first housing 201 has the mirror element 101 secured to a front of the housing. In one embodiment, the stand 102 is secured to the first housing 201.

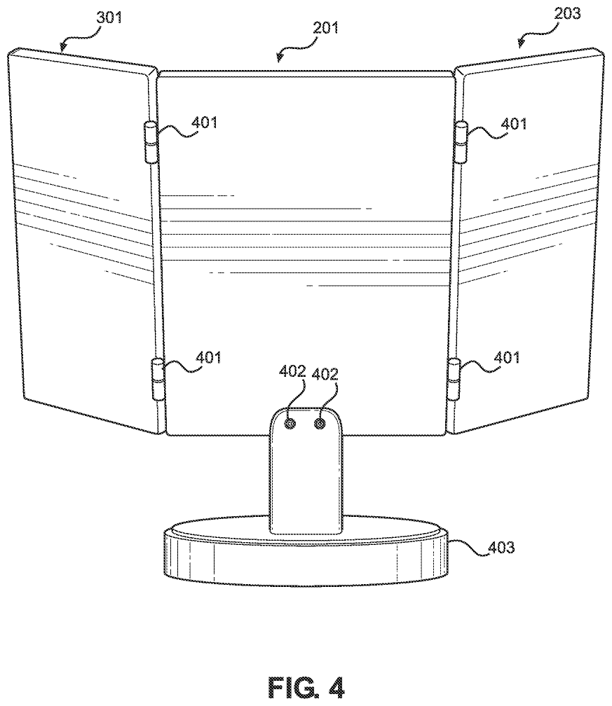

In another embodiment, the device further includes a second housing 203. The second housing 203 is comprised of a plurality of sidewalls 204. The second housing 203 is secured to the first housing 201. This will create an enlarged device. In one embodiment, as further described in FIG. 4, the second housing 203 is movably secured to the first housing 201.

In one embodiment, the second housing 203 holds the first display screen 103. This will allow for the mirror element 101 to not have an aperture cut therein. This will further allow one tc have the first display screen 103 on a same level as one's eyes in use. This will make it easier to watch both the first display screen 103 and the mirror element 101.

In one embodiment, the second housing 203 includes at least one device holder 205. In the shown embodiment, the device holder 205 is an indent into the second housing 203, wherein the indent is dimensioned to correspond to an item. The indent will allow for a similarly shaped item to be removably secured within the device holder 205. In the shown embodiment, the device holder 205 is configured to hold make-up brushes. In other embodiments, the device holder 205 is configured to hold other items.

Further, in some embodiments, the second housing 203 is configured to hold various types of make-up 206. In the shown embodiment, the make-up 206 is circular palettes. In some embodiments, the make-up 206 is replaceable. This will allow for make-up 206 to be replaced as needed. In other embodiments, the make-up 206 is located in a tray 207. In this embodiment, the entire tray 207 would have to be replaced as needed.

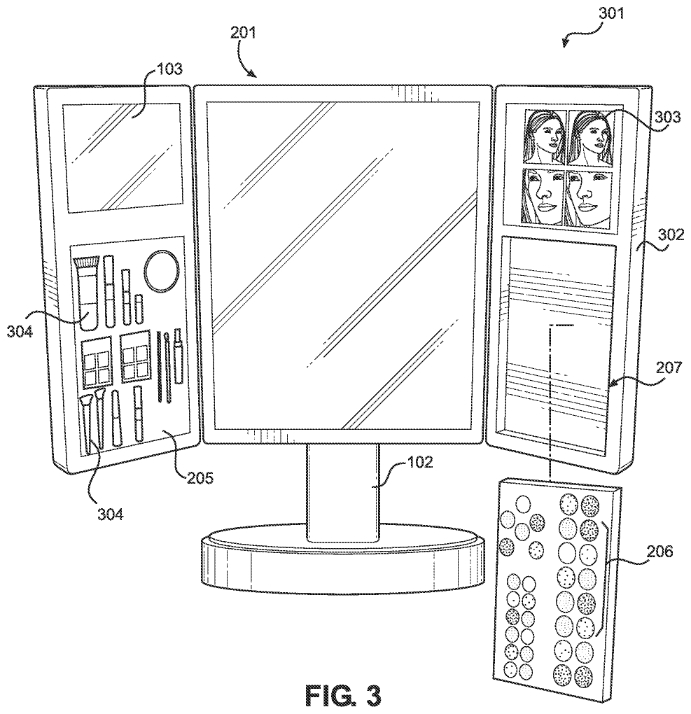

Referring now to FIG. 3, there is shown a front view of an embodiment of the mirror with a built-in display screen. In a further embodiment, there is a third housing 301. The third housing 301 includes a plurality of sidewalk 302. In one embodiment, the third housing 301 is secured to the first housing 201. In one embodiment, the third housing 301 is movably secured to the first housing 201 as described in FIG. 4.

In one embodiment, a second display screen 303 is secured to the second housing 301. The second display screen 303 is configured to display various pictures and videos. In one embodiment, the second screen 303 is configured to display different items from the first display screen 103. For example, the second display screen 303 can be configured to display an image of the current user, which may be obtained via an optionally embedded camera, or may be obtained remotely from an external device such as a smartphone with its own camera or image storage capabilities. The system is configured to overlay outlines atop the image of the user. The outlines define areas that receive makeup to achieve a particular pattern or style. In this way, the user can accurately apply the makeup by filling in the outlined areas shown in the display.

In different embodiments, the third housing 301 includes various types of make-up 206. In the shown embodiment, the make-up 206 comprises a palette of circular sections. In some embodiments, the make-up 206 is replaceable. This will allow for make-up 206 to be replaced as needed. In other embodiments, the make-up 206 is located in a tray 207. In this embodiment, the entire tray 207 would have to be replaced as needed.

In other embodiments, the third housing 301 includes at least one device holder 205. In the shown embodiment the device holder 205 is an indent into the second housing. The indent will allow for a similarly shaped item to be removably secured within the device holder 205. In the shown embodiment, the device holder 205 is configured to hold make-up brushes 304. In other embodiments, the device holder 205 is configured to hold other items.

Referring now to FIG. 4, there is shown rear view of an embodiment of the mirror with a built-in display screen. In one embodiment, the second housing 203 is movably secured to the first housing 201. In the shown embodiment, hinges 401 are used to secure the second housing 203 and the first housing 201. Hinges 401 will allow the second housing 203 to be properly positioned as desired by a user. In a further embodiment, the third housing 301 is movably secured to the first housing 201. In the shown embodiment, hinges 401 are used to secure the third housing 301 and the first housing 201. Hinges 401 will allow the third housing 301 to be properly positioned as desired by a user.

In the shown embodiment, the stand 102 is secured to a rear sidewall of the first housing 201. In one embodiment, the stand is secured to the first housing 201 via a plurality of fasteners 402. In one embodiment, the stand 102 is has a widened base 403 which will allow the stand 102 to hold up the first housing 201, the second housing 203, and the third housing 301.

Referring now to FIG. 5, there is shown a wiring diagram of an embodiment of the mirror with a built-in display screen. The mirror with a built-in display screen includes a power source 501. In one embodiment, the power source 501 is a battery. In another embodiment, the power source 501 is a power cord. In one embodiment, the power source 501 is secured to at least one light 502. The light may be used to illuminate the mirrors as described above. The power 501 is further secured to the first display screen 102 and the second display screen 303.

The power source 501 is further connected to a wireless transceiver 504. The wireless transceiver 504 is wirelessly coupled to a network 503. In one embodiment, the network 503 could also be another data source such as a mobile device. The network 503 will allow various pictures and videos to be sent to the wireless transceiver 504. The wireless transceiver 504 is connected to the first display screen 102 and the second display screen 303. This will allow the pictures and videos from the network 503 to be displayed on the display screens 102, 303. The second display screen is further capable of displaying images of the user, which may be obtain via a camera or via a remote connection between the network 503 and a device having stored images, such as a smartphone or other computer. The displayed images 303 can include an outline around a location that makeup should be applied. For example, the outline can be applied to an image of the user's face to show a particular style or pattern for applying eyeliner. This allows the user to more accurately form the design on themselves, using a combination of the mirror and the displayed images to fill in the outlined areas on themselves with the makeup of their choosing.

It is therefore submitted that the instant invention has been shown and described in what is considered to be the most practical and preferred embodiments. It is recognized, however, that departures may be made within the scope of the invention and that obvious modifications shill occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships o those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A mirror with a built-in display screen, the mirror comprising:
a housing comprising of a plurality of exterior walls;
a mirror element secured to a front side of the housing;
a display screen secured within the housing such that the display screen is viewed when the mirror is viewed;
the display screen is electrically coupled to a wireless transceiver and a power source located within the housing.

2) The mirror with a built-in display screen of claim 1, further comprising a base secured to one of the plurality of sidewalls of the housing;
wherein the base will support the housing.

3) The mirror with a built-in display screen of claim 1, further comprising a plurality of make-up options secured within the first housing.

4) The mirror with a built-in display screen of claim 1, further comprising a plurality of device securing locations within the first housing.

5) A mirror with a built-in display screen, the mirror comprising:
a first housing comprising a plurality of exterior walls;
a mirror element secured to a front side of the first housing;
as second housing comprising a plurality of exterior walls;
a display screen secured within the second housing such that the display screen is viewed when the mirror is viewed;
the display screen is electrically coupled to a wireless transceiver and a power source located within the first housing.

6) The mirror with a built-in display screen of claim 5, wherein the first housing is hingedly secured to the second housing.

7) The mirror with a built-in display screen of claim 5, further comprising a base secured to one of the plurality of sidewalk of the first housing;
wherein the base will support the first housing and the second housing.

8) The mirror with a built-in display screen of claim 5, further comprising a plurality of device securing locations within the first housing.

9) The mirror with a built-in display screen of claim 5, further comprising a plurality of make-up options secured within the first housing.

10) The mirror with a built-in display screen of claim 5, further comprising a plurality of device securing locations within the first housing.

11) The mirror with a built-in display screen of claim 5, further comprising a plurality of make-up options secured within the second housing.

12) The mirror with a built-in display screen of claim 5, further comprising a plurality of device securing locations within the second housing.

13) A mirror a built-in display screen, the mirror comprising:
a first housing comprising a plurality of exterior walls;
a mirror element secured to a front side of the first housing;
as second housing comprising a plurality of exterior walls;
a display screen secured within the second housing such that the display screen is viewed when the mirror is viewed;
the display screen is electrically coupled to a wireless transceiver and a power source located within the first housing;
a third housing comprising a plurality of exterior walls;
a second display screen secured within the third housing such that the second display screen is viewed when the mirror is viewed;
the second display screen is electrically coupled to the wireless transceiver and the power source.

14) The mirror with a built-in display screen of claim 13, wherein the first housing is hingedly secured to the second housing.

15) The mirror with a built-in display screen of claim 13, further comprising a base secured to one of the plurality of sidewalk of the first housing;
wherein the base will support the first housing and the second housing.

16) The mirror with a built-in display screen of claim 13, further comprising a plurality of device securing locations within the first housing.

17) The mirror with a built-in display screen of claim 13, further comprising a plurality of make-up options secured within the first housing.

18) The mirror with a built-in display screen of claim 13, further comprising a plurality of device securing locations within the first housing.

19) The mirror with a built-in display screen of claim 13, further comprising a plurality of make-up options secured within the second housing.

20) The mirror with a built in display screen of claim 13, wherein the second display screen is configured to display an image of the user with an outline defining a location for user application of a particular makeup pattern.
